(19) United States
(12) Patent Application Publication
(10) Pub. No.: US 2015/0251147 A1
(43) Pub. Date: Sep. 10, 2015

(54) Double-screw screw-spindle pump of single flow design

(71) Applicant: Jung and Co. Geratebau GMBH, Kummerfeld (DE)

(72) Inventors: Weshen Christov, Buckeburg (DE); Hans Jung, Pinneberg (DE)

(73) Assignee: Jung and Co. Geratebau GMBH, Kummerfeld (DE)

(21) Appl. No.: 14/630,447

(22) Filed: Feb. 24, 2015

(30) Foreign Application Priority Data
Feb. 24, 2014 (DE) DE102014002396.6

(51) Int. Cl. B01F 7/00; A47J 43/07

(52) U.S. Cl. CPC B01F 7/00975; A47J 43/07; B01F 2215/0014

(57) ABSTRACT

The invention relates to a double-screw screw-spindle pump (10) of single flow design having a pump housing (11) which has a pump section (12), a bearing section (16) and a gear mechanism section (17) with a gear mechanism space (32), the bearing section (16) and the pump section (12) being configured separately from one another, having a conveyor housing part (13) as a constituent part of the pump section (12), in which two conveying screws (24, 25) which have flanks (42, 43) and are arranged on shafts (22, 23) are provided, the shafts (22, 23) being mounted in the bearing section (26) (external bearing) and extending into the gear mechanism section (17). It is an object of the invention to improve the abovementioned pump such that highly viscous, non-flowing media can be conveyed. The object is achieved by virtue of the fact that the pump housing (11) has an extruder section (14) which is connected to the pump section (12), that an extruder housing part (15) is provided, through which the shafts (22, 23) extend, and that extruder screws (27, 28) with flanks (50, 51) are provided on the shafts (22, 23).

The invention relates to a double-screw screw-spindle pump of single flow design having a pump housing which has a pump section, a bearing section and a gear mechanism section with a gear mechanism space, the bearing section and the pump section being configured separately from one another, having a conveyor housing part as a constituent part of the pump section, in which two conveying screws which have flanks and are arranged on shafts are provided, the shafts being mounted in the bearing section (external bearing) and extending into the gear mechanism section.

A pump construction of this type is known from DE 10 2012 001 700 A1. Said pumps are distinguished, in particular, by product-considerate operation and associated low wear. The disclosed screw-spindle pumps are provided with sliding ring seals between the pump section and the bearing section. Reversible conveying, in particular, becomes possible as a result. The sliding ring seal lies at the inlet or at the outlet of the pump as a result. The conveying screws are situated in the pump housing within the pump section. They are enclosed by the conveyor housing part and together form conveyor chambers. The conveying screws are attached on the shafts which end in a gear mechanism section. Gearwheels are arranged on the shafts in the gear mechanism section, by means of which gearwheels the shafts are rotationally coupled.

The conveying screws are arranged in such a way that they are in engagement. They have in each case a corresponding pitch and a corresponding width of the screw threads. The conveyor chambers are situated between the screw threads. During the rotation of the shafts and therefore of the conveying screws, the medium to be pumped is displaced in said conveyor chambers from the inlet to the outlet.

One difficulty in this type of pump lies in pumping highly viscous, non-flowing media. The medium does not reach the conveyor chambers and pumping of the medium is correspondingly not possible. As a solution for this, extruders are connected upstream of the pump, by means of which extruders the highly viscous, non-flowing medium is moved into the pump, with the result that the pump can then pump the medium. The extruders which are connected upstream frequently have the problem that they cannot be used readily, in particular, for the foodstuffs sector, since they often cannot be cleaned sufficiently. They also have high investment costs.

Furthermore, the pump is worthy of improvement, since dead spaces are produced as a result of the sliding ring seals, in which dead spaces material remains, with the result that cleaning is possible with difficulty. This problem exists, in particular, in the case of highly viscous, non-flowing media.

It is an object of the invention to improve the abovementioned pump in such a way that highly viscous, non-flowing media can be conveyed.

The object is achieved by virtue of the fact that the pump housing has an extruder section which is connected to the pump section, that an extruder housing part is provided, through which the shafts extend, and that extruder screws with flanks are provided on the shafts.

As a result of the provision of an extruder section which is integrated into the pump, it becomes possible in a simple way to pump highly viscous, non-flowing media. At the same time, external and expensive extruders which are difficult to clean are dispensed with.

A further teaching of the invention provides that the extruder section is provided between the pump section and the bearing section. As a result, the medium is moved away from the bearing section. The bearing seal is therefore not pressure-loaded and can be of correspondingly simpler design.

A further teaching of the invention provides that the extruder screws have a pitch which is substantially equal or identical to a pitch of the conveying screws.

A further teaching of the invention provides that the width of a screw thread of the extruder screw is smaller than the width of the conveying screw. As a result, it becomes possible in a simple way to maintain relatively large conveyor chambers while maintaining a substantially constant pitch.

A further teaching of the invention provides that there is a hydraulic separation between the pump section and the bearing section or the extruder section and the bearing section, preferably via a lip seal. It has been shown that, as a result of the provision of a lip seal, firstly the sealing requirements can be maintained and at the same time the dead space in the seal region can be reduced considerably.

A further teaching of the invention provides that a feeding hopper is provided in the region of the extruder section. By way of the feeding hopper, the highly viscous, non-flowing medium can be introduced in a simple way into the conveyor spaces of the extruder screw. This is helpful, in particular, in the case of media which have a tendency to adhere to walls. As an alternative, a flange can be provided as a stop on the extruder inlet.

A further teaching of the invention provides that a conveyor chamber with a width is provided between two screw threads of the conveying screw and/or the extruder screw, the width of which corresponds substantially to the axial length of the pitch minus the wall thickness of the screw thread. As a result, it becomes possible to keep the pitch of the conveying screws/extruder screws constant and at the same time to provide sufficient conveyor spaces.

In the following text, the invention will be explained in greater detail using one exemplary embodiment in conjunction with a drawing, in which:

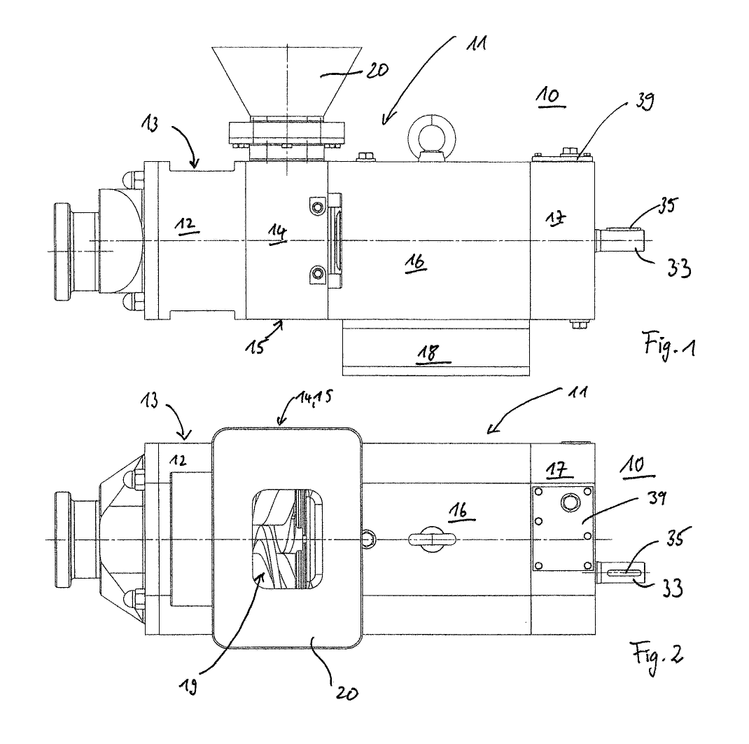

FIG. 1 shows a side view of a pump according to the invention,

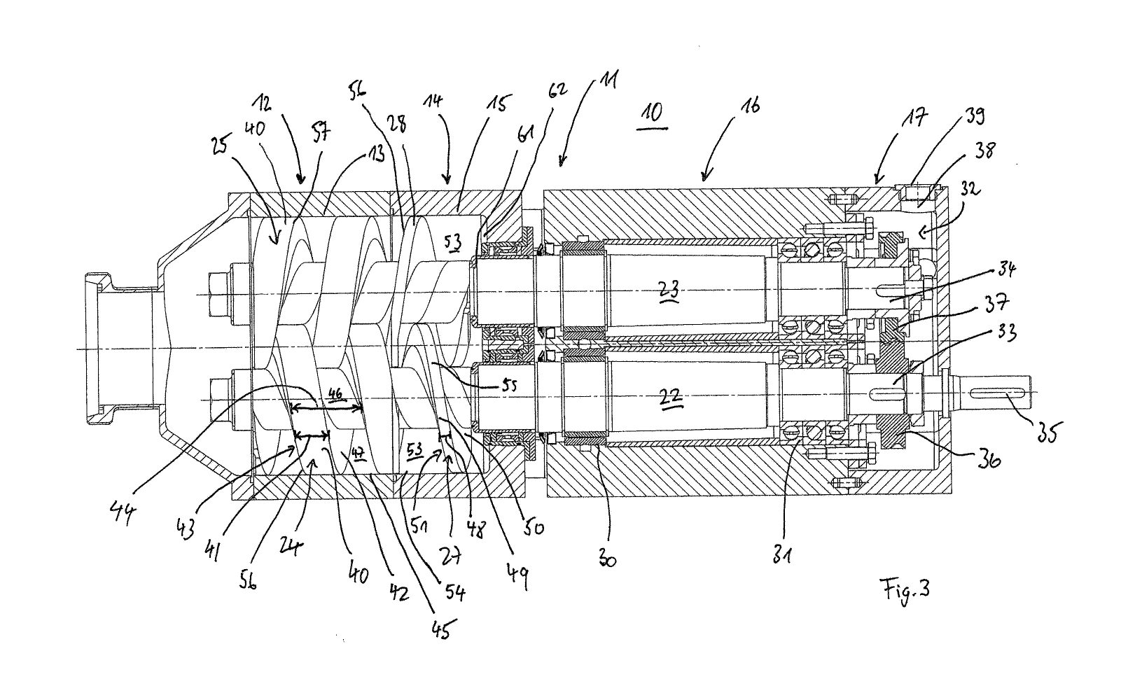

FIG. 2 shows a plan view with respect to FIG. 1,

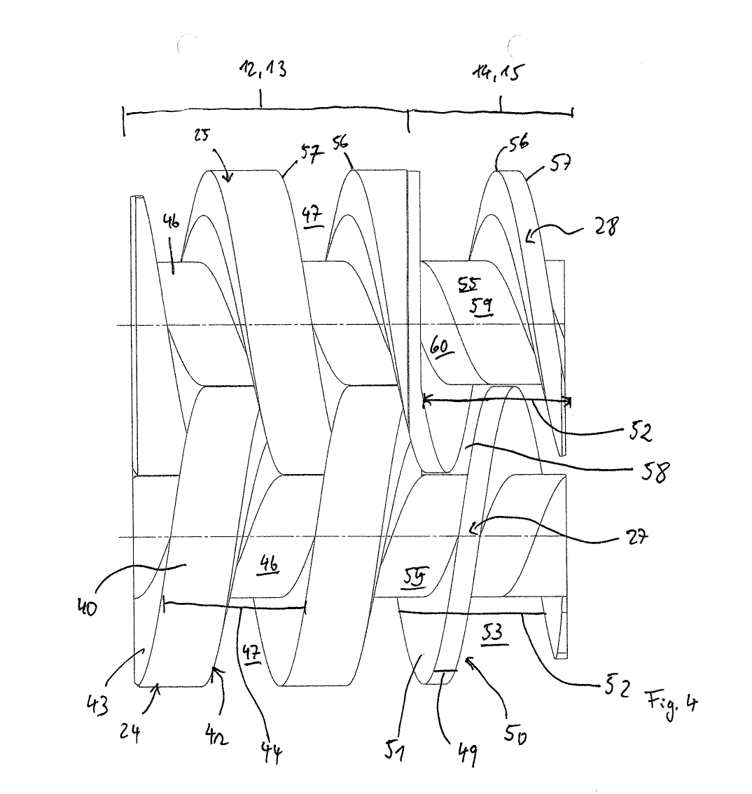

FIG. 3 shows a sectional view with respect to FIG. 2, and

FIG. 4 shows a detailed view of the conveying screws according to the invention.

FIG. 1 shows a side view of a spindle pump 10 according to the invention. FIG. 2 shows a plan view with respect to FIG. 1. The spindle pump 10 has a housing 11 which has a pump section 12 with a conveyor housing part 13, an extruder section 14 with an extruder housing part 15, a bearing section 16 and a gear mechanism section 17. The sections are separated from one another spatially, a hydraulic separation also being provided between the pump section 12 in conjunction with the extruder section 14 and the bearing section 16, or the gear mechanism section 17. A base plate 18 is provided on the housing 10. The extruder section 14 has an opening 19, above which a feeding hopper 20 is attached via a flange 21.

The spindle pump 10 has a powered shaft 22 and a driven shaft 23. A conveying screw 24 is arranged on the powered shaft 22 and a conveying screw 25 is arranged on the driven shaft 23, which conveying screws 24, 25 are in engagement. The conveying screws 24, 25 are situated in a corresponding bore 26 in the conveyor housing part 13.

An extruder screw 27 is arranged on the powered shaft 22 and an extruder screw 28 is arranged on the driven shaft 23, which extruder screws 27, 28 are likewise in engagement. The extruder screws 27, 28 are provided in the extruder housing part 15 in a corresponding bore 29. The bore 29 is open with the opening 19 on the upper side, with the result that the medium to be conveyed can enter into the extruder housing part.

The shafts 22, 23 are mounted by way of needle bearings 30 and roller bearings 31 in the bearing section 16. The gear mechanism section 17 has a gear mechanism space 32, into which the shaft ends 33, 34 of the shafts 22, 23 extend. The shaft end 33 of the powered shaft 22 extends out of the housing 11 and has a connector 35 there for a drive unit (not shown). A gearwheel 36 is situated on the powered shaft 22. A gearwheel 37 is arranged on the driven shaft 23. The teeth of the gearwheels 36, 37 are situated in meshing engagement.

The gear mechanism space 32 has an opening 38 which is closed by way of a cover 39. The flank play of the conveying screws 24, 25 and/or of the extruder screws 27, 28 can be set through the opening 38.

The conveying screws 24, 25 have in each case one screw thread 40. The screw thread 40 has a width 41 which corresponds to the material thickness or wall thickness of the screw thread. Furthermore, the screw thread has in each case one flank 42, 43. Furthermore, the screw thread 40 has a pitch 44, which means the spacing of two adjacent flanks 42 or adjacent flanks 43. An inner wall 45 of the bore 26 of the conveyor housing part 13 in conjunction with the two flanks 42, 43 and a side face 46 of the screw thread 40, situated in between, of the other shaft which is in engagement at this point form a conveyor chamber 47.

The extruder screws 27, 28 also have in each case one screw thread 48 with a width 49. The screw threads 48 have in each case flanks 50, 51. Furthermore, the screw thread 48 has a pitch 52 in an analogous manner to the pitch 44. In the exemplary embodiment which is shown, the pitch 52 is identical to the pitch 44. Conveyor chambers 53 are also provided with regard to the extruder screws 27, 28, which conveyor chambers 53 are formed by the inner wall 54 of the bore 29 of the extruder housing part 15, the flanks 50, 51 and the side face of a screw thread 55.

The conveying screws 24, 25 and the extruder screws 27, 28 are configured in such a way that the medium to be conveyed is transferred directly from the extruder screws 27, 28 to the conveying screws 24, 25 at the transition from the extruder housing part 15 to the conveyor housing part 13. This is possible firstly because the pitch 52 of the extruder screws 27, 28 is as great as the pitch 44 of the conveying screws 24, 25. Furthermore, the surface line 56 of the flank 43 is continuously progressive in the pitch of the screw thread 40 at the transition to the respective extruder screw 27, 28. The surface line 57 of the flank 50 changes in the transition region from the conveyor housing part 13 to the extruder housing part 15 in such a way that an axial offset is carried out at the transition from the screw thread 40 to the screw thread 48 in such a way that the width 49 of the extruder screw 27, 28 is reduced correspondingly. After the reduction, the pitch of the surface line 57 also again runs identically with the pitch 52. As a result, a transfer of the medium to be conveyed from the larger conveyor chamber 53 to the smaller conveyor chamber 47 is made possible in a simple way.

The larger conveyor chamber 53 in turn makes it possible for the material of the highly viscous, non-flowing medium to enter into the conveyor chamber between the flanks 50 and 51 of a respective screw thread 48, with the result that an entry of the medium into the spindle pump 10 is then possible with performance of the pumping operation per se. The reduction in the width 49 of the screw threads 48 produces a connecting space 58 between the conveyor chambers 53, with the result that a pressure increase in the extruder section 14 is avoided, in order to make entry of the medium into the extruder screws 27, 28 possible.

It can be seen from FIG. 4 that, furthermore, the pitch 52 is identical to the pitch 44 of the conveying screws 24, 25. The side face 55 of the extruder screws 27, 28 is composed of a first side wall section 59 and a second side section 60. The side wall section 60 in conjunction with the width 49 corresponds to the width 41 of the screw thread 40 of the conveying screws 24, 25. The first side wall section 59 is identical to the side face 46 of the conveying screws 24, 25.

The bearing section 16 is sealed with respect to the extruder section 14 by means of a lip seal 61. As a result, a dead space 62 which is present is minimized in such a way that it is possible to remove the medium which passes into said space out of the dead space 62 by way of the extruder screw 27, 28. Moreover, the use of the lip seal 61 makes possible dry running of the pump 10 possible and the use of the pump 10 in conjunction, in particular, with tacky media, such as chewing gum mass or the like.

List of Reference Numerals:

| | |
|---|---|
| 10 | Spindle pump |
| 11 | Housing |
| 12 | Pump section |
| 13 | Conveyor housing part |
| 14 | Extruder section |
| 15 | Extruder housing part |
| 16 | Bearing section |
| 17 | Gear mechanism section |
| 18 | Base plate |
| 19 | Opening |
| 20 | Feeding hopper |
| 21 | Flange |
| 22 | Powered shaft |
| 23 | Driven shaft |
| 24 | Conveying screw |
| 25 | Conveying screw |
| 26 | Bore |
| 27 | Extruder screw |
| 28 | Extruder screw |
| 29 | Bore |
| 30 | Needle bearing |
| 31 | Roller bearing |
| 32 | Gear mechanism space |
| 33 | Shaft end |
| 34 | Shaft end |
| 35 | Connector |
| 36 | Gearwheel |
| 37 | Gearwheel |
| 38 | Opening |
| 39 | Cover |
| 40 | Screw thread |
| 41 | Width |
| 42 | Flank |
| 43 | Flank |
| 44 | Pitch |
| 45 | Inner wall |
| 46 | Side face |
| 47 | Conveyor chamber |
| 48 | Screw thread |
| 49 | Width |
| 50 | Flank |
| 51 | Flank |
| 52 | Pitch |
| 53 | Conveyor chamber |
| 54 | Inner wall |
| 55 | Side face |
| 56 | Surface line |
| 57 | Surface line |
| 58 | Connecting space |
| 59 | First side wall section |
| 60 | Second side wall section |
| 61 | Lip seal |
| 62 | Dead space |

1. Double-screw screw-spindle pump of single flow design having a pump housing which has a pump section, a bearing section and a gear mechanism section with a gear mechanism space, the bearing section and the pump section being configured separately from one another, having a conveyor housing part as a constituent part of the pump section, in which two conveying screws which have flanks and are arranged on shafts are provided, the shafts being mounted in the bearing section (external bearing) and extending into the gear mechanism section, characterized in that the pump housing has an extruder section which is connected to the pump section, in that an extruder housing part is provided, through which the shafts extend, and in that extruder screws with flanks are provided on the shafts.

2. Spindle pump according to claim 1, characterized in that the extruder section is provided between the pump section and the bearing section.

3. Spindle pump according to claim 1, characterized in that the extruder screws have a pitch which is substantially equal or identical to a pitch of the conveying screws.

4. Spindle pump according to one of claims 1, characterized in that the width of a screw thread of the extruder screw is smaller than the width of the conveying screw.

5. Spindle pump according to one of claims 1, characterized in that there is a hydraulic separation between the pump section and the bearing section or the extruder section and the bearing section, preferably via a lip seal.

6. Spindle pump according to one of claims 1, characterized in that a feeding hopper is provided in the region of the extruder section.

7. Spindle pump according to one of claims 1, characterized in that a conveyor chamber with a width is provided between two screw threads of the conveying screw and/or the extruder screw, the width of which corresponds substantially to the axial length of the pitch minus the wall thickness of the screw thread.
